(19) United States
(12) Patent Application Publication
(10) Pub. No.: US 2019/0292849 A1
(43) Pub. Date: Sep. 26, 2019

(54) MANUAL TO MOTORIZED CONVERTIBLE ROLLER BLINDS

(71) Applicant: TTI (Macao Commercial Offshore) Limited, Macau (MO)

(72) Inventors: J. Porter Whitmire, Greenville, SC (US); Austin Clark, Greenville, SC (US)

(73) Assignee: TTI (Macao Commercial Offshore) Limited, Macau (MO)

(21) Appl. No.: 16/356,819

(22) Filed: Mar. 18, 2019

Related U.S. Application Data
(60) Provisional application No. 62/646,010, filed on Mar. 21, 2018.

(51) Int. Cl. E06B 9/74; E06B 9/72; E06B 9/44

(52) U.S. Cl. CPC E06B 9/74; E06B 9/44; E06B 9/72

(57) ABSTRACT

A window covering assembly includes a bracket, a roller channel for supporting a blinds covering, and a roller motor module. Protrusions are provided on the inside surface of the roller channel, and these protrusions engage recesses that are provided on the roller motor module. Roller motor module imparts a rotational force on the roller channel to extend or retract the blinds covering through the protrusions and recesses. The window covering may be converted from a manually-operated configuration to a motorized configuration. Prior to such a conversion, the assembly does not include the roller motor module but instead includes a roller spring module that includes recesses for engaging with the protrusions of the roller channel. When a user manually extends the blinds covering, rotation of the roller channel energizes a spring on the roller spring module, which imparts a rotational force in the direction of retraction of the blinds covering.

This application claims the benefit of U.S. Provisional Application No. 62/646,010, filed Mar. 21, 2018, the contents of which are hereby incorporated by reference in their entirety.

### SUMMARY

The present subject matter relates to a window covering assembly that is configured to be converted from a manually-operated state to a motorized state and a method of such conversion. Such conversion may be facilitated by way of replacing a roller spring module with a roller motor module as described herein.

In one embodiment, the window covering assembly is and/or includes a roller blinds assembly with a roller channel supported by a bracket. The roller channel receives a roller spring module on one end when the assembly is in a manually-operated state and a roller motor module in the same end when in the motorized state. A roller blind covering of the roller blinds assembly is supported by the roller channel and a roller blind cap at the end opposite the end that receives the roller spring module or roller motor module. The roller blind covering may be caused to extend and/or retract respective to a portion of the window covering assembly based on commands or controls executed by the roller motor module.

### BRIEF DESCRIPTION OF THE DRAWINGS

FIG. 1 is a perspective view of a window covering assembly in a manually-operated state according to one embodiment of the present subject matter.

FIG. 2 is a perspective view of a window covering assembly, with the roller channel removed, in a manually-operated state according to one embodiment of the present subject matter.

FIG. 3 is a perspective view of a window covering assembly in a motorized state according to one embodiment of the present subject matter.

FIG. 4 is a perspective view of a window covering assembly, with the roller channel removed, in a motorized state according to one embodiment of the present subject matter.

FIG. 5 is an end view of a roller channel according to one embodiment of the present subject matter.

FIG. 6 is a perspective view of a roller spring module according to one embodiment of the present subject matter.

FIG. 7 is a perspective view of a roller motor module according to one embodiment of the present subject matter.

FIG. 8 is a block diagram of some of the components of a roller motor module according to one embodiment of the present subject matter.

### DETAILED DESCRIPTION OF THE PREFERRED EMBODIMENT

Reference will now be made in detail to the preferred embodiment of the present subject matter, which is illustrated in the accompanying drawings.

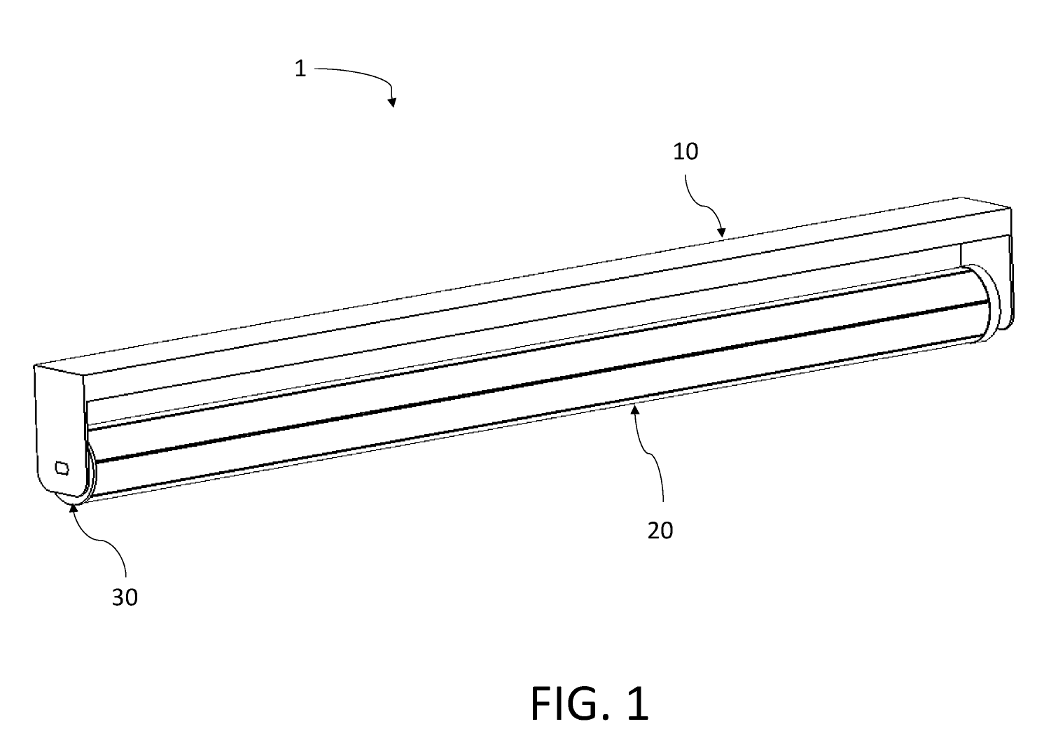

FIG. 1 shows a window covering assembly 1 in a manually-operated stated according to one embodiment of the present subject matter. Window covering assembly 1 may be a roller blinds assembly comprising a roller blind covering or cover (e.g., a plastic cover, a fabric cover, and/or the like). The window covering assembly 1 may include a roller channel 20 for attaching to and/or otherwise supporting the roller blind covering (not shown). In one embodiment, the roller channel 20 may be supported by a roller blind bracket 10. On one end of the roller channel 20, a roller blind cap 30 may be provided for supporting roller channel 20 and the roller blind covering attached thereto.

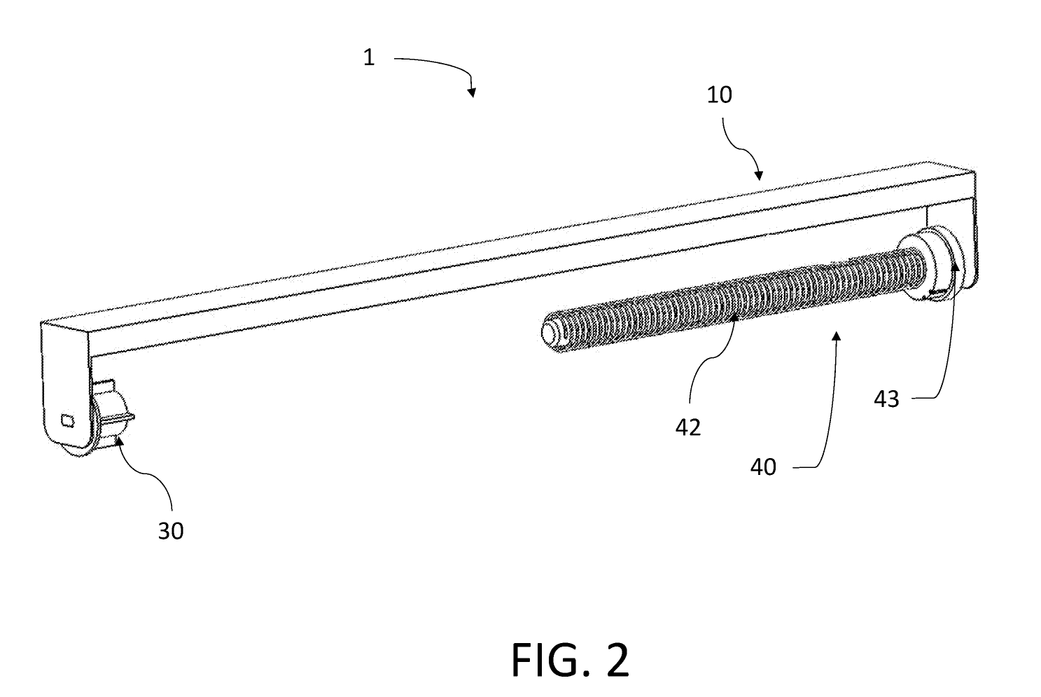

With reference to FIG. 2, which shows the window covering assembly 1 with the roller channel 20 removed, a roller spring module 40 may be provided on at least one end of the roller blind bracket 10, for example, opposite an end at which the roller blind cap 30 is disposed. The roller spring module 40 may support the roller blind channel 20 and roller blind covering. In the illustrated embodiment, the roller spring module 40 includes a spring 42 (e.g., a coiled spring, a helical spring, and/or the like) and spring module body 43.

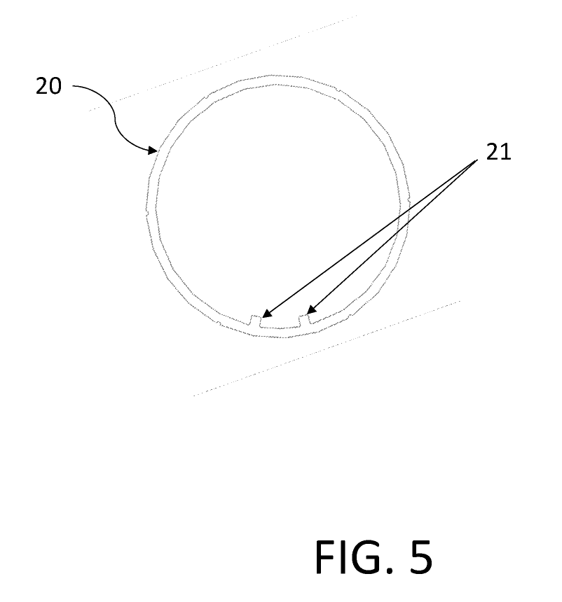

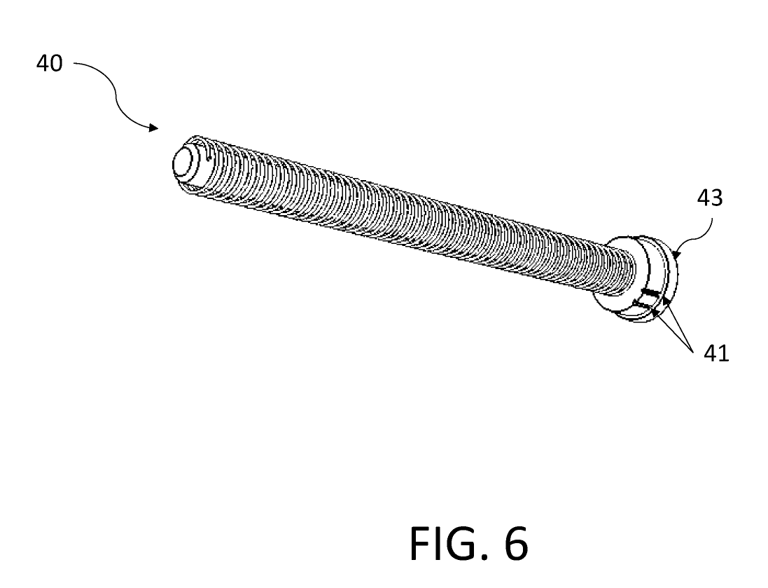

With reference to FIG. 5, which is an end view of roller channel 20, in one embodiment, protrusions 21 (e.g., ridges, flanges, and/or the like) are provided on the inside of roller channel 20. With reference to FIG. 6, which is a perspective view of roller spring module 40, notches 41 (e.g., grooves, slots, recesses, and/or the like) may be provided in spring module body 43. In one embodiment, when roller spring module 40 is disposed in roller channel 20, protrusions 21 engage with notches 41. When a user manually grasps and, extends the roller blind covering, the roller channel 20 rotates, and by way of the engagement of protrusions 21 and notches 41, spring module body 43 rotates with roller channel 20. In one embodiment, one end of the spring 42 is engaged with spring module body 43, and another end of spring 42 may be stationary. Thus, such rotation energizes spring 42. When a user manually retracts the roller blind covering (e.g., via applying a force, releasing the covering, and/or the like), the energized spring 42 imparts a rotational force on spring module body 43, and by way of the engagement of protrusions 21 and notches 41, a rotational force is likewise imparted on roller channel 20. This force reduces the manual force required to be exerted by the user.

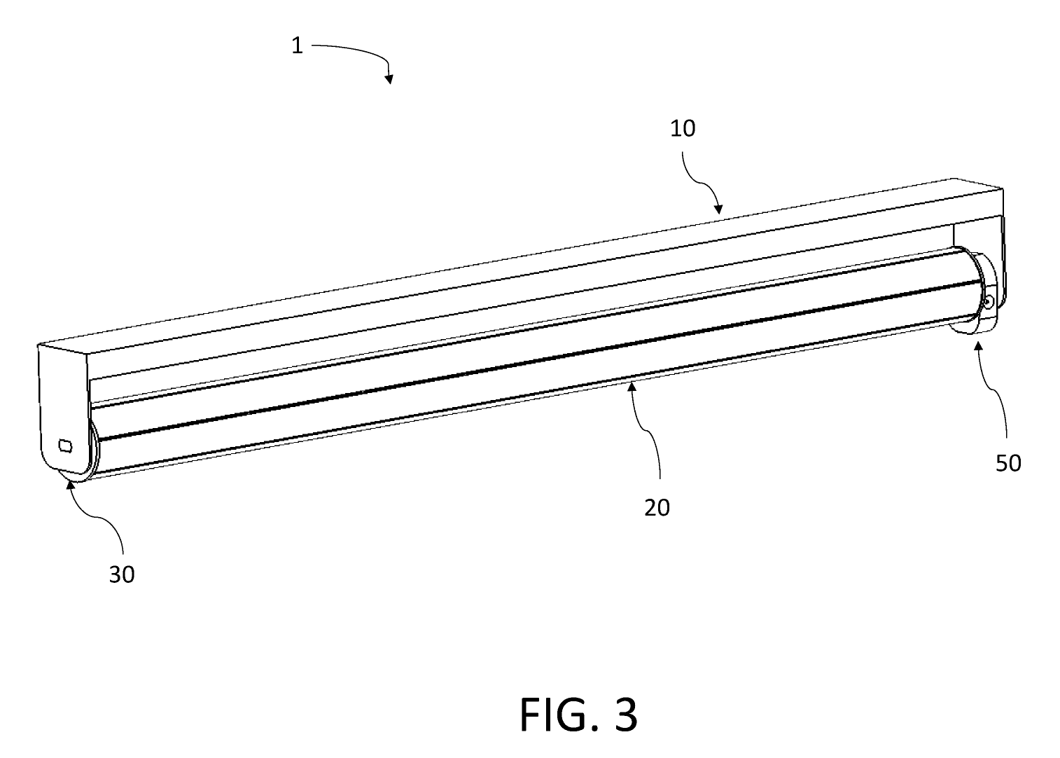

FIG. 3 shows the window covering assembly 1 in a motorized state according to one embodiment of the present subject matter. Many of the same components as are present in the manually-operated state may be present in the motorized state, such as roller blind bracket 10, roller channel 20, and/or roller blind cap 30. The same reference numerals as are used in FIG. 1 are used to refer to these components in FIG. 3.

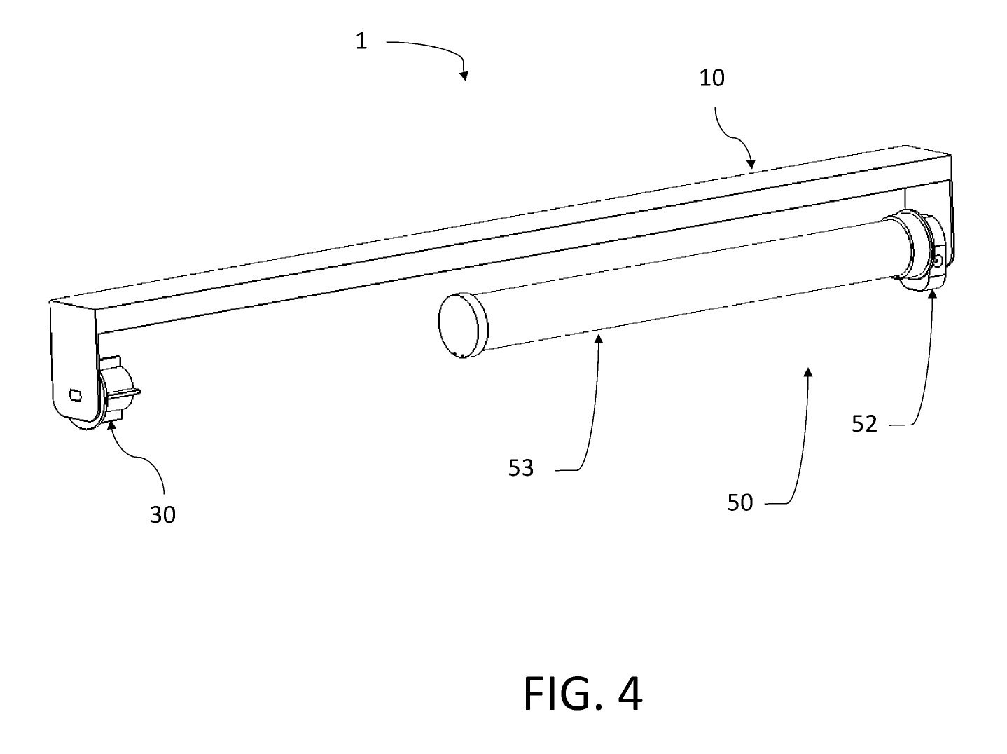

In the motorized state, a roller motor module 50 (more fully shown in FIG. 4) is provided. The roller motor module 50 may be configured to automate the extension and/or retraction of the roller blind covering for improving the ease of operation and/or control of such covering. Roller motor module 50 may be integrated with window covering assembly 1 or roller motor module 50 may be a discrete component (e.g., separate from window covering assembly 1) that is configured for insertion within a portion (e.g., a portion of bracket 10, roller channel 20, and/or cap 30) of window covering assembly 1.

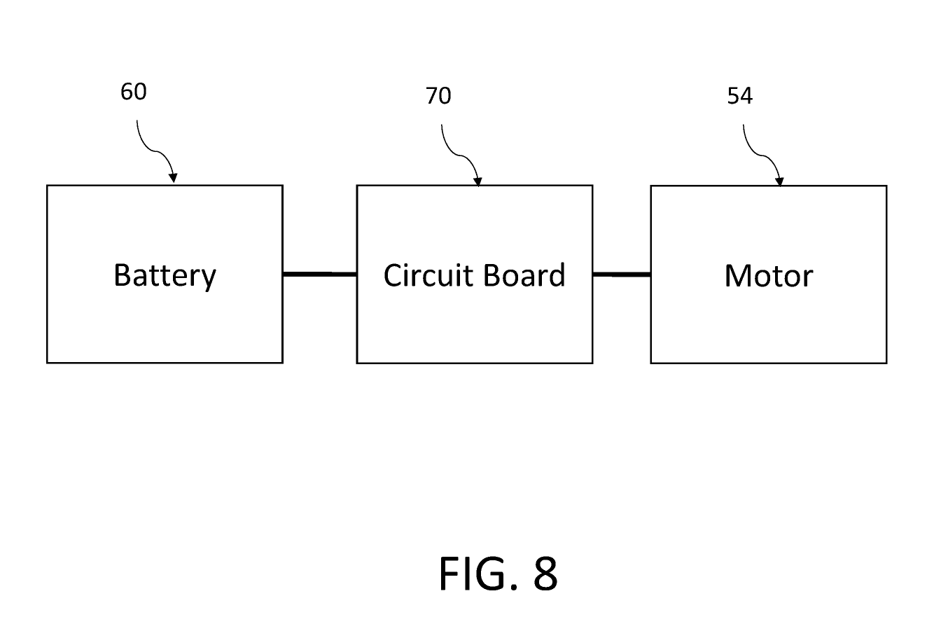

As shown in FIG. 4, which shows the window covering assembly 1 with roller channel 20 removed, roller motor module 50 may support roller channel 20 near an end of the roller blind bracket 10 opposite that at which the roller blind cap 30 is disposed. Roller motor module 50 may include a stationary portion 52 and a rotating portion 53. Rotating portion 53 is configured to support roller channel 20, and rotate respective to stationary portion 52 by way of a motor 54 (see FIG. 8) disposed in and/or associated with roller motor module 50. In one embodiment, the rotating portion 53 and the roller channel 20 are each generally cylindrical and are disposed so that their respective center axes are co-axial. In one embodiment, the rotation of rotating portion 53 imparts a torque on roller channel 20, and rotating portion 53 and roller channel 20 co-rotate. In this way, the roller blind covering attached to the roller channel 20 may be caused to extend and/or retract respective to the stationary portion 52 and bracket 10.

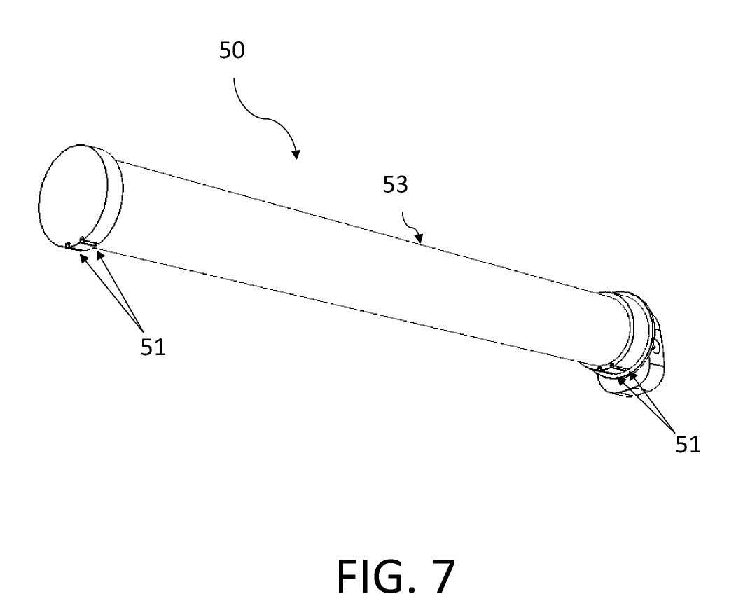

With reference to FIG. 7, in one embodiment, roller motor module 50 includes notches 51 disposed on rotating portion 53. When the roller motor module 50 is disposed on, over, and/or in roller channel 20, protrusions 21 of roller channel 20 engage with notches 51 of the rotating portion 53. When the rotating portion 53 rotates in response to a command, by way of engagement of protrusions 21 and notches 51, the roller motor module 50 rotates roller channel 20 to thereby extend or retract the roller blind covering attached to roller channel 20.

With reference to FIG. 8, in some embodiments, the motor 52 provided or housed in motor module 50 causes rotating portion 53 to rotate based on commands communicated via a circuit board 70 of roller motor module 50 and/or components disposed on a circuit board 70 of roller motor module 50. In this way, the roller blind covering attached to the roller channel 20 being actuated by rotating portion 53 may move respective to the bracket 10 of window covering assembly 1. For example, in some embodiments a processor component, such as a microcontroller, a digital signal processor (DSP), a system on a chip (SoC), an integrated circuit (IC), control circuitry, and/or the like, is configured to control the motor 52 of roller motor module 50 for inducing or causing the extension, retraction, and/or other movement of the roller blind covering of window covering assembly 1. Such control may be implemented by way of the processor component reading and executing software instructions stored in a memory component (e.g., a non-transitory memory device such as a RAM, a ROM, a flash memory, an optical memory, and/or the like) of motor module 50, which is in electrical communication with the processor component of motor module 50. When executed, the software instructions stored in the memory component may cause the processor component to perform one or more processes described herein. Additionally, or alternatively, hardwired circuitry may be used in place of or in combination with software instructions to perform one or more processes described herein. Thus, the embodiments described herein are not limited to any specific combination of hardware circuitry and software.

In one embodiment, the motor module 50 includes a battery 60, which supplies power to the motor module 50. In one embodiment, rotating portion 53 houses battery 60 and circuit board 70, and stationary portion houses motor 54.

It will be apparent to those skilled in the art that various modifications and variations can be made in the manual to motorized convertible roller blinds of the present subject matter. Thus, it is intended that the present subject matter covers modifications and variations of this subject matter provided within the scope of the appended claims and equivalents of the appended claims.

What is claimed is:

1. A window covering assembly comprising:
a bracket;
a roller channel supported by the bracket,
the roller channel being configured to support a roller blind covering; and
a roller motor module,
the roller motor module including:
a rotating portion attached to the roller channel; and
a stationary portion disposed proximate to an end of the roller channel,
the stationary portion being configured to house a motor, and
the motor being configured to co-rotate the rotating portion and the roller channel respective to the stationary portion for extending and retracting the roller blind covering.

2. The window covering assembly of claim 1, wherein the rotating portion and the roller channel are coaxial.

3. The window covering assembly of claim 1, wherein a recess of the rotating portion engages a projection of the roller channel for facilitating co-rotation of the rotating portion and the roller channel.

4. The window covering assembly of claim 1, wherein the stationary portion is disposed between portions of the bracket and the roller channel.

5. The window covering assembly of claim 1, wherein the roller blind covering comprises a plastic covering or a fabric covering.

6. The window covering assembly of claim 1, further comprising a battery,
wherein the rotating portion houses the battery.

7. The window covering assembly of claim 1, further comprising a circuit board,
wherein the rotating portion houses the circuit board.

8. A window covering assembly comprising:
a bracket;
a roller channel that is supported by the bracket,
the roller channel being configured to support a roller blind covering; and
a roller spring module;
the roller spring module including:
a spring module body engaged with the roller channel; and
a spring, one end of which is stationary and another end of which is attached to the spring module body,
wherein the spring module body is configured such that rotation of the roller channel co-rotates the spring module body, and
wherein a recess of the spring module body engages a projection of the roller channel for facilitating co-rotation of the spring module body and the roller channel.

9. The window covering assembly of claim 8,
wherein the spring, the roller channel, and the spring module body are arranged such that the spring is not energized when the roller blind covering is in a first position, and the spring is energized when the roller blind covering is a second position, and
wherein the second position is lower than the first position.

10. The window covering assembly of claim 8, wherein the roller blind covering comprises a plastic covering or a fabric covering.

11. A method, comprising:
disposing a roller channel that is configured to support a roller blind covering on a bracket;
disposing at least a portion of a roller motor module in the roller channel,
wherein the roller motor module includes:
a rotating portion attached to the roller channel;
a stationary portion disposed proximate to an end of the roller channel,
wherein the stationary portion is configured to house a motor, and
wherein the motor is configured to co-rotate the rotating portion and the roller channel respective to the stationary portion for extending and retracting the roller blind covering.

12. The method of claim 11, wherein the rotating portion and the roller channel are coaxial.

13. The method of claim 11, wherein a recess of the rotating portion engages a projection of the roller channel for facilitating co-rotation of the rotating portion and the roller channel.

14. The method of claim 11, further comprising the step of disposing the stationary portion between portions of the bracket and the roller channel.

15. The method of claim 11, wherein the roller blind covering comprises a plastic covering or a fabric covering.

16. The method of claim 11, further comprising the step of disposing a battery in the rotating portion.

17. The method of claim 11, further comprising the step of disposing a circuit board in the rotating portion.

18. The method of claim 11, further comprising the step of actuating the motor to extend the roller blind covering.

19. The method of claim 11, further comprising the step of actuating the motor to retract the roller blind covering.

20. The method of claim 11 further comprising the step of removing a roller spring module from the roller channel prior to disposing a portion of the roller motor module in the roller channel.
